(19) United States
(12) Patent Application Publication
(10) Pub. No.: US 2024/0300495 A1
(43) Pub. Date: Sep. 12, 2024

(54) DRIVING ASSISTANCE DEVICE

(71) Applicant: TOYOTA JIDOSHA KABUSHIKI KAISHA, Aichi (JP)

(72) Inventor: Takayuki ASOMA, Toyota-shi (JP)

(21) Appl. No.: 18/583,861

(22) Filed: Feb. 22, 2024

(30) Foreign Application Priority Data
Mar. 6, 2023 (JP) 2023-033492

(51) Int. Cl. B60W 30/16

(52) U.S. Cl. CPC B60W 30/16; B60W 2420/408; B60W 2520/10; B60W 2554/802

(57) ABSTRACT

A driving assistance device comprising: a camera sensor that photographs a front of a vehicle; and a control unit configured to perform deceleration control to automatically decelerate the vehicle when a deceleration target is detected based on an image photographed by the camera sensor, the control unit being configured to, when the control unit detects a notifying target that previously informs presence of a deceleration target based on an image photographed by the camera sensor, set a target vehicle speed of the vehicle at a position of the deceleration target corresponding to the notifying target based on the notifying target, set a provisional deceleration pattern of the vehicle based on a vehicle speed at a time when the notifying target was detected and the target vehicle speed, and perform temporary deceleration control to automatically decelerate the vehicle according to the provisional deceleration pattern.

### CROSS-REFERENCE TO RELATED APPLICATION

This application claims priority to Japanese Patent Application No. JP2023-33492 filed on Mar. 6, 2023, the content of which is hereby incorporated by reference in its entirety into this application.

### BACKGROUND

### 1. Technical Field

The present disclosure relates to a driving assistance device for a vehicle such as an automobile.

### 2. Description of the Related Art

As a driving assistance device for a vehicle such as an automobile, a driving assistance device is known that is configured to automatically decelerate a vehicle when a deceleration target, i.e. a target that needs to be approached by reducing a vehicle speed by decelerating, such as a crosswalk without traffic lights is detected.

For example, in Japanese Patent Application Laid-open No. 2021-88289, a driving assistance device is described that is configured to calculate detection reliability of a deceleration target so that it increases as a distance to the deceleration target decreases, and reduce a degree of assistance in decelerating a vehicle when the detection reliability is low, as compared to when the detection reliability is high.

In a conventional driving assistance device such as the driving assistance device described in the above-mentioned Laid-open publication, deceleration is not started unless a deceleration target is detected and the detection reliability becomes equal to or higher than a reference value. If performance of a photographing device for detecting a deceleration target is poor, a distance at which a deceleration target is detected by the photographing device is short, and a vehicle speed is high, rapid deceleration is started when a vehicle approaches the deceleration target. Therefore, it may not be possible to automatically decelerate the vehicle without impairing sense of security of an occupant or occupants.

### SUMMARY

The present disclosure provides an improved driving assistance device that can automatically decelerate a vehicle without compromising sense of security of an occupant or occupants by decelerating the vehicle using a notifying target that previously informs presence of a deceleration target.

According to the present disclosure, a driving assistance device is provided which comprises: a photographing device that photographs a front of a vehicle; and a control unit configured to perform deceleration control to automatically decelerate the vehicle when a deceleration target is detected based on an image photographed by the photographing device.

The control unit is configured to, when the control unit detects a notifying target that previously informs presence of a deceleration target based on an image photographed by the photographing device, set a target vehicle speed of the vehicle at a position of the deceleration target corresponding to the notifying target based on the notifying target, set a provisional deceleration pattern of the vehicle based on a vehicle speed at a time point when the notifying target was detected and the target vehicle speed, and perform provisional deceleration control to automatically decelerate the vehicle according to the provisional deceleration pattern.

According to the above configuration, when a notifying target that previously informs presence of a deceleration target is detected, a provisional deceleration pattern for a vehicle is set, and provisional deceleration control is performed to automatically decelerate the vehicle according to the provisional deceleration pattern. the provisional deceleration pattern the target vehicle speed of the vehicle at a position of a deceleration target corresponding to the notifying target is set based on the notifying target, and is set based on a vehicle speed at a time point when the notifying target is detected and the target vehicle speed.

Therefore, it is possible to set the provisional deceleration pattern using a notifying target that previously informs presence of a deceleration target, and to start the provisional deceleration control performed according to the provisional deceleration pattern before the deceleration target is detected. Accordingly, it is possible to prevent rapid deceleration from starting when the vehicle approaches the deceleration target, and to automatically decelerate the vehicle without impairing sense of security of an occupant or occupants.

In one aspect of the present disclosure, the control unit is configured to, when the control unit detects the deceleration target corresponding to the notifying target based on the image photographed by the photographing device in a situation where the provisional deceleration control is performed, estimate a remaining traveling distance from a present position of the vehicle to the deceleration target, set a final deceleration pattern of the vehicle based on the vehicle speed at a time point when the deceleration target was detected, the target vehicle speed, and the remaining traveling distance, and perform final deceleration control to automatically decelerate the vehicle according to the final deceleration pattern.

In another aspect of the present disclosure, the vehicle has a navigation device, and the control unit is configured to acquire information on a present position of the vehicle from the navigation device, and determine a start timing of the provisional deceleration control by determining whether or not the vehicle has reached a deceleration start position of the provisional deceleration pattern based on the present position of the vehicle and the provisional deceleration pattern.

Further, in another aspect of the present disclosure, the control unit includes a storage device that stores, for each deceleration target, information on a standard distance between a deceleration target and a notifying target that previously informs presence of a deceleration target, and is configured to, when the control unit detects a notifying target that previously informs presence of a deceleration target, estimate a distance from the present position of the vehicle to the notifying target, acquire information on a standard distance corresponding to the notifying target from the storage device, estimate a provisional traveling distance from a present position of the vehicle to the deceleration target corresponding to the notifying target based on the estimated distance and the acquired standard distance, and determine a start timing of the provisional deceleration control by determining whether or not the vehicle has reached a deceleration start position of the provisional deceleration pattern based on a traveling distance of the vehicle from a time point when the notifying target was detected, the provisional traveling distance, and the provisional deceleration pattern.

Further, in another aspect of the present disclosure, the vehicle has a radar device that detects a distance between the vehicle and a target in front of the vehicle, and the control unit is configured to, when the control unit detects a notifying target that previously informs presence of a deceleration target, estimate a distance from the present position of the vehicle to the notifying target based on a distance detected by the radar device.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing a driving assistance device according to an embodiment.

FIG. 2 is a flowchart corresponding to a deceleration control program in the first embodiment.

FIG. 3 is a flowchart corresponding to a deceleration control program in the second embodiment.

FIG. 4 is a diagram illustrating operation of the first embodiment in a case where a deceleration target is detected without a preliminary sign being detected.

FIG. 5 is a diagram illustrating operation of the first embodiment in a case where a deceleration target is detected after a preliminary sign is detected.

FIG. 6 is a diagram illustrating operation of the second embodiment in a case where a deceleration target is detected after a preliminary sign is detected.

### DETAILED DESCRIPTION

A driving assistance device according to the embodiment of the present disclosure will be described in detail below with reference to the accompanying drawings.

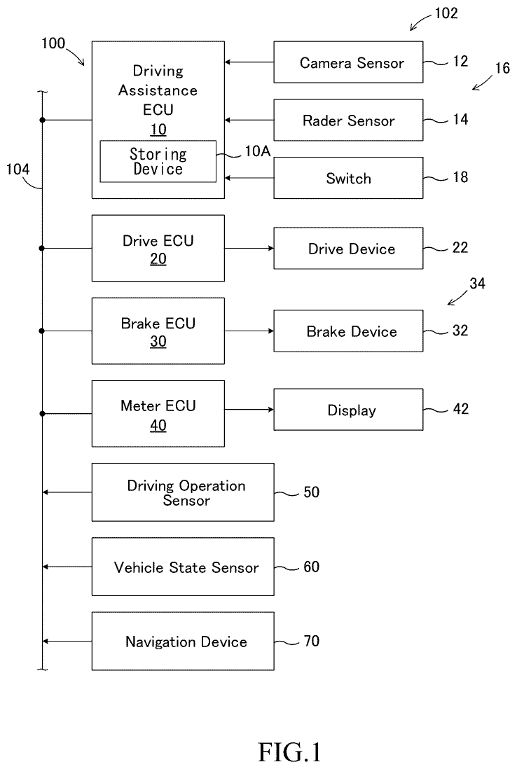

As shown in FIG. 1, a driving assistance device 100 according to an embodiment of the present disclosure is applied to a vehicle 102 and includes a driving assistance ECU 10. The vehicle 102 may be a vehicle capable of autonomous driving. As shown in FIG. 1, the vehicle 102 includes a drive ECU 20, a brake ECU 30, and a meter ECU 40. ECU means an electronic control unit having a microcomputer as its main part.

A microcomputer of each ECU includes a CPU, a ROM, a RAM, a readable and writable nonvolatile memory (N/M), an interface (I/F), and the like. The CPU implements various functions by executing instructions (programs, routines) stored in the ROM. Furthermore, these ECUs are connected to each other via a CAN (Controller Area Network) 104 so as to be able to exchange data (communicate). Therefore, detected values of sensors (including switches) connected to a specific ECU are transmitted to other ECUs as well.

The driving assistance ECU 10 is a central control unit that performs driving assistance control such as deceleration control, follow-up inter-vehicle distance control and lane keeping control. In the embodiment, the driving assistance ECU 10 cooperates with other ECUs to perform the deceleration control by automatic braking, as will be described in detail later.

A camera sensor 12, a radar sensor 14 and a switch 18 are connected to the driving assistance ECU 10. The camera sensor 12 and the radar sensor 14 include a plurality of camera devices and a plurality of radar devices, respectively. The camera sensor 12 and the radar sensor 14 function as a target detection device 16 that detects targets at least in front of the vehicle 102. The camera sensor 12 serves as a photographing device that photographs at least a front of the vehicle. The radar sensors 14 may be omitted.

Although not shown in the figures, each camera device of the camera sensors 12 includes a camera unit that captures images of surroundings of the vehicle 102, and a recognition unit that analyzes the image data captured by the camera unit and recognizes deceleration targets such as road signs, preliminary signs, and targets such as other vehicles. The recognition unit supplies information about a recognized target to the driving assistance ECU 10 every time a predetermined time elapses.

As is well known, each radar device of the radar sensors 14 uses radio waves in a millimeter wave band to detect a relative distance and a relative speed between the own vehicle and a three-dimensional object, a relative position (direction) of the three-dimensional object with respect to the own vehicle, and the like, and supplies detected information to the driving assistance ECU 10. LIDAR (Light Detection And Ranging) may be used instead of or in addition to the radar sensor 14.

The switch 18 is provided at a position that can be operated by a driver, such as at a steering wheel not shown in FIG. 1, and is turned on and off by the driver. When the switch 18 is on, a signal indicating this is supplied to the driving assistance ECU 10, and the deceleration control by the automatic braking is executed.

The drive ECU 20 is connected to a drive device 22 that accelerates the vehicle 102 by applying driving force to drive wheels not shown in FIG. 1. The drive ECU 20 normally controls the drive device 22 so that the driving force generated by the drive device 22 changes according to a driving operation by the driver, and when the drive ECU 20 receives a command signal from the driving assistance ECU 10, the drive ECU 20 controls the drive device 22 based on the command signal.

Note that the drive device 22 is not limited to a combination of an internal combustion engine and an automatic transmission. That is, the drive device 22 may be any drive device known in the art such as a combination of an internal combustion engine and a continuously variable transmission, a so-called hybrid system that is a combination of an internal combustion engine and a motor, a so-called plug-in hybrid system, a combination of a fuel cell and a motor, or a motor.

The brake ECU 30 is connected to a brake device 32 that decelerates the vehicle 102 by applying braking force to wheels (not shown in FIG. 1). The brake ECU 30 normally controls the brake device 32 so that the braking force generated by the brake device 32 changes according to a braking operation by the driver, and, when the brake ECU 30 receives a command signal from the driving assistance ECU 10, the brake ECU 30 performs automatic braking by controlling the brake device 32 based on the command signal. Therefore, the brake ECU 30 and the brake device 32 function as an automatic brake device 34 that executes the deceleration control of the vehicle by the automatic braking.

A display 42 is connected to the meter ECU 40 to display a status of control executed by the driving assistance ECU 10 and the like. The display 42 may be, for example, a head-up display or a multi-information display that displays meters and various piece of information, or may be a display of a navigation device.

A driving operation sensor 50 and a vehicle state sensor 60 are connected to the CAN 104. Information detected by the driving operation sensor 50 and the vehicle state sensor 60 (referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 50 includes a driving operation amount sensor that detects an operation amount of an accelerator pedal, a braking operation amount sensor that detects a master cylinder pressure or a pressing force on a brake pedal, and a brake switch that detects whether or not the brake pedal is operated. Further, the driving operation sensor 50 includes a steering angle sensor that detects a steering angle, and a steering torque sensor that detects a steering torque, and the like.

The vehicle state sensor 60 includes a vehicle speed sensor that detects a vehicle speed V of the vehicle 102, a longitudinal acceleration sensor that detects a longitudinal acceleration of the vehicle, a lateral acceleration sensor that detects a lateral acceleration of the vehicle, a roll angular acceleration sensor that detects a roll angular acceleration of the vehicle, and a yaw rate sensor that detects a yaw rate of the vehicle, and the like.

Furthermore, a navigation device 70 is also connected to the CAN 104. The navigation device 70 includes a GPS receiver that detects a position of the vehicle 102, a storage device that stores map information and road information, and a communication device that acquires a latest map information and road information from outside. The road information includes a piece of information about deceleration targets. The navigation device 70 functions as a device that acquires information on a present position of the vehicle 102, and outputs a signal indicating the present position of the vehicle on a map and map information of its surroundings to the driving assistance ECU 10.

### First Embodiment

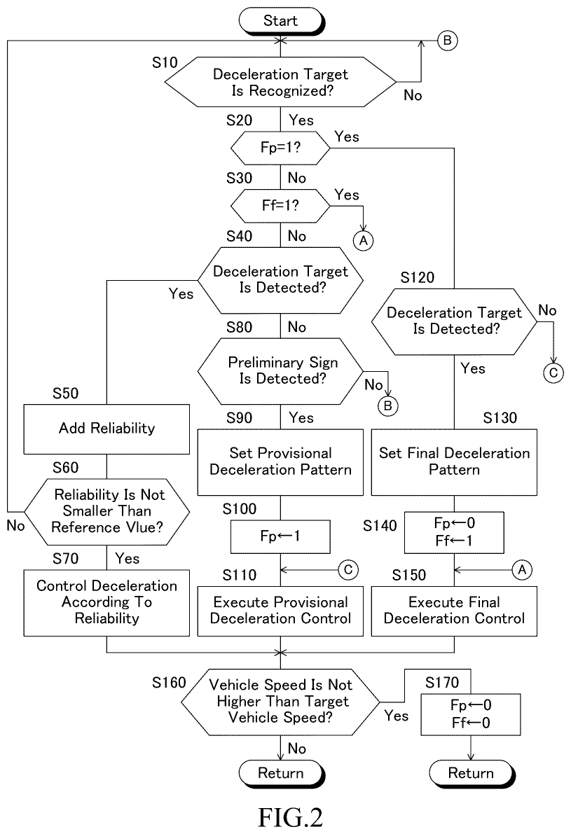

The ROM of the driving assistance ECU 10 is part of the storage device 10A shown in FIG. 1, and in the first embodiment, the ROM stores a program for the deceleration control by the automatic braking. This program corresponds to the flowchart shown in FIG. 2, and the deceleration control is executed according to this flowchart.

### <Deceleration Control Program in First Embodiment>

Next, the deceleration control in the first embodiment will be described with reference to the flowchart shown in FIG. 2. The deceleration control according to the flowchart shown in FIG. 2 is repeatedly executed by the CPU of the driving assistance ECU 10 at predetermined time intervals when the switch 18 is on, and ends when the switch 18 is turned off.

First, in step S10, the CPU determines whether or not a deceleration target is recognized by determining whether or not a signal indicating that a deceleration target exists in front of the vehicle 102 from the navigation device 70 is input. When a negative determination is made, the control once ends, and when an affirmative determination is made, the control proceeds to step S20. Note that at the start of this control, flags Fp and Ff, which will be described later, are initialized to 0 prior to step S10.

Although not shown in FIG. 2, in step S10, when a deceleration target is recognized and a distance from a present position of the vehicle to the deceleration target becomes less than an accelerator-off reference value, a command signal is output to the drive ECU 20. As a result, the driving force of the drive device 22 is reduced to zero.

In step S20, the CPU determines whether or not the flag Fp is 1, that is, determines whether or not provisional deceleration control, which will be described later, is being executed. When an affirmative determination is made, the control proceeds to step S120, and when a negative determination is made, the control proceeds to step S30.

In step S30, the CPU determines whether or not the flag Ff is 1, that is, determines whether or not final deceleration control, which will be described later, is being executed. When an affirmative determination is made, the control proceeds to step S150, and when a negative determination is made, the control proceeds to step S40.

In step S40, the CPU determines whether or not a deceleration target is detected in front of the vehicle 102, based on targets photographed and analyzed by the camera sensor 12. When a negative determination is made, the control proceeds to step S80, and when an affirmative determination is made, the control proceeds to step S50.

In step S50, the CPU adds reliability R of deceleration target detection. Although an amount of reliability addition may be constant, in the embodiment, it is changed according to the number of consecutive executions of step S50 so that it becomes smaller as the number of consecutive executions of step S50 increases. Therefore, the reliability R increases as the number of consecutive executions of step S50 increases, but the rate of increase decreases as the number of consecutive executions of step S50 increases.

In step S60, the CPU determines whether the reliability R of deceleration target detection is greater than or equal to a preset reference value Rc (a positive constant). When a negative determination is made, the control once ends, and when an affirmative determination is made, the control proceeds to step S70.

In step S70, the CPU calculates a target deceleration Gbt of the vehicle 102 according to the reliability of deceleration target detection so that the higher the reliability, the larger the target deceleration Gbt. Further, the CPU outputs a command signal to the brake ECU 30 to control deceleration Gb of the vehicle according to the reliability so that the deceleration of the vehicle becomes the target deceleration Gbt.

In step S80, the CPU determines whether or not a preliminary sign, which is a notifying target that previously informs presence of a deceleration target in front of the vehicle 102, is detected based on targets photographed and analyzed by the camera sensor 12. When a negative determination is made, the control once ends, and when an affirmative determination is made, the control proceeds to step S90.

In step S90, the CPU identifies a deceleration target based on the preliminary sign, and sets a target vehicle speed Vt of the vehicle 102 at a position of the deceleration target based on the deceleration target. Furthermore, the CPU obtains information about a distance from a present position of the vehicle to the deceleration target (provisional travel distance Lp) from the navigation device 70, and sets a provisional deceleration pattern to bring a vehicle speed V at the position of the deceleration target to the target vehicle speed Vt based on a present vehicle speed Vp of the vehicle, the target vehicle speed Vt, and the provisional travel distance Lp.

In this case, the provisional deceleration pattern is set to have an increased deceleration section, a constant deceleration section, and a decreased deceleration section. A distance Lb over which deceleration is performed according to the provisional deceleration pattern is set to be less than or equal to the provisional travel distance Lp. In other words, a deceleration start position of the provisional deceleration pattern is set closer to the deceleration target than the present position of the vehicle.

In step S100, the CPU sets the flag Fp to 1. Note that the flag Ff is maintained at 0.

In step S110, the CPU determines whether or not the vehicle 102 is located at the deceleration start position of the provisional deceleration pattern or a position past it, based on information about the present position of the vehicle from the navigation device 70. That is, the CPU determines whether or not it is the deceleration start timing according to the provisional deceleration pattern or thereafter. When an affirmative determination is made, a target deceleration Gbpt of the provisional deceleration pattern is determined based on the present position of the vehicle. Further, by outputting a command signal to the brake ECU 30, the provisional deceleration control is executed to control the deceleration Gb of the vehicle so that the deceleration of the vehicle becomes the target deceleration Gbpt. Note that if it is determined that the vehicle 102 has not yet reached the deceleration start position of the provisional deceleration pattern, the control proceeds to step S160 without controlling the deceleration of the vehicle.

In step S120, the CPU determines whether or not a deceleration target corresponding to the preliminary sign detected in step S80 has been detected in front of the vehicle 102, based on targets photographed and analyzed by the camera sensor 12. When a negative determination is made, the control proceeds to step S110, and when an affirmative determination is made, the control proceeds to step S130.

In step S130, the CPU acquires information about a remaining distance Lf from a present position of the vehicle 102 to the deceleration target from the navigation device 70. Further, the CPU sets a final deceleration pattern for bringing a vehicle speed V at the deceleration target position to the target vehicle speed Vt based on a present vehicle speed Vp of the vehicle, the target vehicle speed Vt, and the remaining distance Lf.

In this case, the final deceleration pattern is set to include a deceleration transition section, a constant deceleration section, and a deceleration decreasing section. Note that the deceleration transition section is a section for changing the deceleration from a present deceleration of the vehicle to a deceleration of the constant deceleration section. When the present deceleration of the vehicle is the same as the deceleration of the constant deceleration section, a deceleration transition section is not required. Further, when the final deceleration pattern is substantially the same as a portion of the provisional deceleration pattern where deceleration is not yet controlled, the final deceleration pattern may be set to be the portion of the provisional deceleration pattern where deceleration is not yet controlled.

In step S140, the CPU resets the flag Fp to 0 and sets the flag Ff to 1.

In step S150, the CPU obtains information on the present position of the vehicle 102 from the navigation device 70, and determines a target deceleration Gbft of the final deceleration pattern based on the present position of the vehicle. Furthermore, the CPU outputs a command signal to the brake ECU 30 to execute the final deceleration control to control the deceleration of the vehicle so that the deceleration Gb of the vehicle becomes the target deceleration Gbft.

In step S160, the CPU determines whether or not the vehicle speed V is less than or equal to the target vehicle speed Vt. When a negative determination is made, the control once ends, and when an affirmative determination is made, in step S170, when the flag Fp or Ff is 1, the flag is reset to 0, and the control once ends.

### <Operation of First Embodiment>

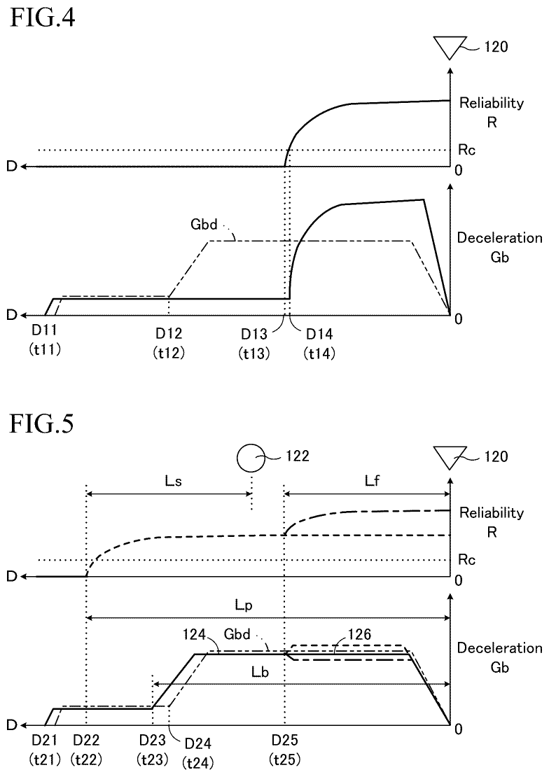

Next, with reference to FIGS. 4 and 5, the operation of the first embodiment will be explained with respect to a case where a deceleration target is detected without a preliminary sign being detected (C1) and the case where a deceleration target is detected after a preliminary sign was detected (C2). In FIGS. 4 and 5 and FIG. 6 which will be described later, the horizontal axis indicates a distance D from the deceleration target.

C1: When a Deceleration Target is Detected without a Preliminary Sign being Detected (FIG. 4)

As shown in FIG. 4, it is assumed that at a time point t11 when the distance D from the deceleration target is D11, based on recognition of the deceleration target by the navigation device 70, accelerator release is started and deceleration by engine braking is started. Furthermore, it is assumed that the camera sensor 12 detects the deceleration target 120 at a time point t13 when the distance D is D13. The two-dot chain line shown in the lower row indicates a change in the vehicle deceleration Gbd when a driver with standard driving skills visually recognizes the deceleration target 120 and performs the braking operation. It is assumed that a time point t12 when the braking operation is started is between the time point t11 and the time point t13.

Since the determination in step S40 becomes affirmative at the time point t13, addition of the reliability R of deceleration target detection is started, and the reliability R increases after the time point t13 as shown. If the reliability R becomes equal to or higher than the reference value Rc at a time point t14 when the distance D is D14, the determination in step S50 becomes affirmative, so that after the time point t14, the deceleration Gb of the vehicle 102 will be controlled according to the reliability R.

Therefore, when a target detection distance of the camera sensor 12 is not long, as in conventional driving assistance devices, the deceleration Gb increases rapidly at a later time compared to the deceleration Gbd generated by a braking operation of the driver, and a maximum value of the deceleration Gb is larger than a maximum value of the deceleration Gbd.

C2: When a Deceleration Target is Detected after a Preliminary Sign was Detected (FIG. 5)

As shown in FIG. 5, it is assumed that at a time point t21 when the distance D is D21, acceleration off is started based on the recognition of a deceleration target by the navigation device 70, and the deceleration by the engine braking is started. Furthermore, it is assumed that the camera sensor 12 detects a preliminary sign 122 and a deceleration target 120 at time points t22 and t25 when the distance D is D22 and D25, respectively. Similar to FIG. 4, the two-dot chain line shown in the lower row indicates a change in the deceleration God of the vehicle when a driver with standard driving skills visually recognizes the deceleration target 120 and performs the braking operation. It is assumed that a time point t24 when the braking operation is started is between the time point t22 and the time point t25.

It is assumed that at the time point t22, the determination in step S80 becomes affirmative, and at a time point t23 when the distance D is D23, step S90 is executed to set a provisional deceleration pattern 124.

At the time point t25, the determination in step S120 becomes affirmative, so that a final deceleration pattern 126 is set. When a maximum deceleration of the final deceleration pattern 126 is substantially the same as a maximum deceleration of the provisional deceleration pattern 124, the remaining portion of the provisional deceleration pattern is set to the final deceleration pattern, as shown by the solid line in FIG. 5. On the other hand, when the maximum deceleration of the final deceleration pattern 126 is larger and smaller than the maximum deceleration of the provisional deceleration pattern 124, the final deceleration pattern changes as shown by the broken line and the dashed-dotted line, respectively.

### Second Embodiment

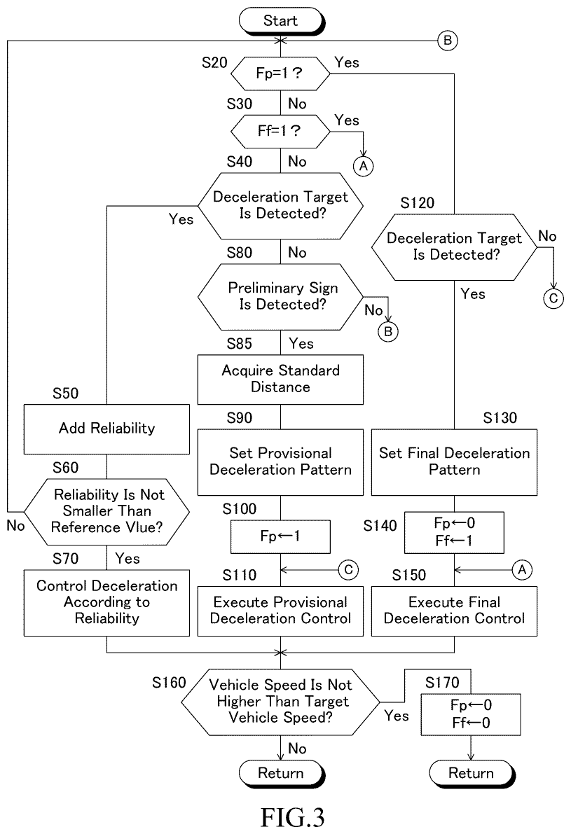

In the second embodiment, the ROM of the driving assistance ECU 10 stores a program for deceleration control by the automatic braking corresponding to the flowchart shown in FIG. 3. The deceleration control is executed according to this flowchart. The second embodiment is applied to a vehicle in which a signal indicating that a deceleration target exists in front of the vehicle 102 is not inputted from the navigation device 70 to the driving assistance ECU 10, or a vehicle not equipped with a navigation device.

In addition, as shown in Table 1 below, the ROM of the driving assistance ECU 10 stores various deceleration targets, preliminary signs (targets that previously inform presence of deceleration targets), and standard distances Ln between them.

TABLE 1

| Deceleration Target | Preliminary Sign | Standard Distance Ln |
|---|---|---|
| Curve | Preliminary Sign Of | Ln1 |
| | Curve | |
| Traffic Light | Preliminary Traffic | Ln2 |
| | Light | |
| Pedestrian Crossing | Preliminary Sign Of | Ln3 |
| | Pedestrian Crossing | |
| Road Width Reduction | Preliminary Sign Of | Ln4 |
| | Road Width Reduction | |
| Construction Location | Preliminary Sign Of | Ln5 |
| | Construction Location | |
| . | . | . |
| . | . | . |
| . | . | . |

### <Deceleration Control Program of Second Embodiment>

Next, deceleration control in the second embodiment will be described with reference to the flowchart shown in FIG. 3. The deceleration control according to the flowchart shown in FIG. 3 is repeatedly executed by the CPU of the driving assistance ECU 10 at predetermined time intervals when the switch 18 is on, and ends when the switch 18 is turned off.

As can be seen from a comparison between FIG. 3 and FIG. 2, in the second embodiment, step S10 is not executed, and steps S20 to S170 are executed in the same manner as in the first embodiment, respectively, except for points described below.

When an affirmative determination is made in step S80, a command signal is output to the drive ECU 20 to reduce the driving force of the drive device 22 to zero as acceleration off. Further, when an affirmative determination is made in step S80, step S85 is executed prior to step S90.

In step S85, the CPU specifies a deceleration target based on the preliminary sign, and acquires information on the standard distance Ln between the preliminary sign and the deceleration target from Table 1 stored in the ROM of the driving assistance ECU 10.

In step S90, the CPU acquires information on a distance Ls from the present position of the vehicle 102 to the preliminary sign from the radar sensor 14 of the target detection device 16. Furthermore, the CPU sets a provisional deceleration pattern to bring a vehicle speed V at the positions of the deceleration target to the target vehicle speed Vt based on a present vehicle speed Vp of the vehicle, the target vehicle speed Vt, and a sum of the distance Ls and the standard distance Ln.

Also in this case, the provisional deceleration pattern is set to have an increased deceleration section, a constant deceleration section, and a decreased deceleration section. The distance Lb over which deceleration is performed according to the provisional deceleration pattern is set to be less than or equal to a sum of the distance Ls and the standard distance Ln. In other words, the deceleration start position of the provisional deceleration pattern is set closer to the deceleration target than the present position of the vehicle.

In step S110, the CPU determines whether or not the vehicle 102 is at or has passed the deceleration start position of the provisional deceleration pattern, based on the sum of the distance Ls and the standard distance Ln and a traveling distance Lr from a time point when the affirmative determination was made in step S80. Therefore, the CPU determines that it is the timing to start deceleration according to the provisional deceleration pattern when Ls+Ln−Lr becomes Lb. When an affirmative determination is made, the CPU determines a target deceleration Gbpt of the provisional deceleration pattern based on the present position of the vehicle. Note that the traveling distance from the time point when the affirmative determination is made in step S80 and the present position of the vehicle may be estimated based on an elapsed time from the time point when the affirmative determination is made in step S80 and history of the vehicle speed.

Further, the CPU outputs a command signal to the brake ECU 30 to execute the provisional deceleration control to control the deceleration of the vehicle 102 so that the deceleration Gb of the vehicle becomes the target deceleration Gbpt. Note that when the CPU determines that the vehicle 102 has not yet reached the deceleration start position of the provisional deceleration pattern, the control proceeds to step S160 without controlling the deceleration of the vehicle.

Further, in step S130, the CPU acquires information on a remaining distance Lf from the present position of the vehicle to the deceleration target from the radar sensor 14 of the target detection device 16. Further, the CPU sets a final deceleration pattern for bringing a vehicle speed V at the deceleration target position to the target vehicle speed Vt based on a present vehicle speed Vp of the vehicle, the target vehicle speed Vt, and the remaining distance Lf.

Furthermore, in step S150, the CPU estimates the present position of the vehicle 102 based on the remaining distance Lf acquired in step S130, and determines a target deceleration Gbft of the final deceleration pattern based on the present position of the vehicle. Furthermore, the CPU outputs a command signal to the brake ECU 30 to execute the final deceleration control to control the deceleration of the vehicle so that the deceleration Gb of the vehicle becomes the target deceleration Gbft.

### <Operation of Second Embodiment>

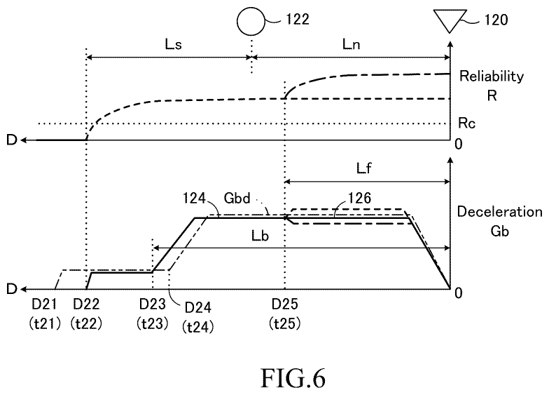

Next, with reference to FIG. 6, the operation of the second embodiment will be described for the case where a deceleration target is detected after a preliminary sign is detected, similar to the case C2 above. Note that in FIG. 6, the same distances and time points as shown in FIG. 5 are shown at distances and time points that are substantially the same as those shown in FIG. 5.

In the second embodiment, at the time point t22 when an affirmative determination is made in step S80, the acceleration off is started and deceleration by the engine braking is started. Further, whether or not the vehicle has arrived at a position where the distance D from the deceleration target is D23 is determined by determining whether or not Ls+Ln-Lr has become Lb. In other respects, the deceleration of the vehicle is controlled similarly to the first embodiment.

As can be seen from the above description, according to the first and second embodiments, when a notifying target that previously informs the presence of a deceleration target 120, that is, a preliminary sign 122 is detected (S80), a provisional deceleration pattern 124 of the vehicle is set (S90), and the provisional deceleration control is performed to automatically decelerate the vehicle according to the provisional deceleration pattern (S110). A target vehicle speed Vt of the vehicle at the position of the deceleration target corresponding to the notifying target is set based on the notifying target, and the provisional deceleration pattern is set based on the vehicle speed Vp at the time point when the notifying target is detected and the target vehicle speed.

Therefore, it is possible to set a provisional deceleration pattern 124 using a notifying target that previously informs presence of a deceleration target 120, and to start provisional deceleration control performed according to the provisional deceleration pattern before the deceleration target is detected. Therefore, it is possible to prevent rapid deceleration from starting when the vehicle 102 approaches a deceleration target or from rapid deceleration due to a rapid increase in deceleration, and to automatically slow down the vehicle without compromising sense of security of an occupant or occupants.

In particular, according to the first and second embodiments, a deceleration Gb according to the provisional deceleration pattern 124 and the final deceleration pattern 126 can be changed according to a change pattern close to that of deceleration Gbd generated by braking operation of a driver with standard driving skills.

Further, according to the first and second embodiments, when a deceleration target is detected in a situation where the provisional deceleration control is being performed (S120), the final deceleration pattern 126 of the vehicle is set (S130), and the final deceleration control is performed to automatically decelerate the vehicle according to the final deceleration pattern (S150). Therefore, as compared to where only the provisional deceleration control is performed according to the provisional deceleration pattern, it is possible to reduce the possibility that the vehicle speed at the position of the deceleration target will not reach the target vehicle speed.

In particular, according to the first embodiment, information on a present position of the vehicle is acquired from the navigation device 70, and based on the present position of the vehicle and the provisional deceleration pattern, the start timing of the provisional deceleration control is determined by determining whether or not the vehicle has reached the deceleration start position of the provisional deceleration pattern. Therefore, using the information from the navigation device, it is possible to reduce the possibility that the provisional deceleration control will be started too early or too late.

Further, according to the second embodiment, when a preliminary sign 122 is detected (S80), a distance Ls from the present position of the vehicle to the preliminary sign is estimated, and the information on the standard distance Ln corresponding to the preliminary sign is acquired from the storage device 10A. Further, based on the estimated distance Ls and the acquired standard distance Ln, a provisional traveling distance Ls+Ln from the present position of the vehicle to the deceleration target 120 is estimated. Furthermore, the start timing of the provisional deceleration control is determined by determining whether or not the vehicle has reached the deceleration start position of the provisional deceleration pattern based on the traveling distance Lr of the vehicle from a time point when the preliminary sign was detected, the provisional traveling distance, and the provisional deceleration pattern. Therefore, as compared to where the standard distance information corresponding to the preliminary sign is not acquired from the storage device, it is possible to reduce the possibility that the provisional deceleration control will be started too early or too late.

Although the present disclosure has been described in detail with reference to specific embodiments, it will be apparent to those skilled in the art that the present disclosure is not limited to the above-described embodiments, and various other embodiments are possible within the scope of the present disclosure.

For example, in the first and second embodiments described above, the reliability R of the deceleration target detection is added when a deceleration target is detected without detecting a preliminary sign. However, the reliability R may be added even when a preliminary sign is detected without detecting a deceleration target, as shown by the broken line in FIGS. 5 and 6. In that case, in step S110, as one of the conditions for starting deceleration according to the provisional deceleration pattern, it may be determined whether or not the reliability R is equal to or greater than the reference value Rc. Furthermore, the reliability R may also be added when a deceleration target is detected in a situation where deceleration is being performed according to the provisional deceleration pattern, as shown by the dashed line in FIGS. 5 and 6.

In addition, in the first and second embodiments described above, when a deceleration target is detected without detecting a preliminary sign, a target deceleration Gbt is calculated according to the reliability R, and the deceleration Gb of the vehicle is controlled so that it becomes the target deceleration Gbt. However, the control of the deceleration of the vehicle when a deceleration target is detected without detecting a preliminary sign may be any control known in the art.

Furthermore, in the second embodiment, the distance Ls between the present position of the vehicle and the preliminary sign and the distance Lf between the present position of the vehicle and the deceleration target are detected by the radar sensor 14 of the target detection device 16. However, the distances between the present position of the vehicle and the preliminary sign and the deceleration target may be detected by a camera sensor. In that case, the camera sensor is preferably a stereo camera sensor, but may be a monocular camera.

What is claimed is:

1. A driving assistance device comprising: a photographing device that photographs a front of a vehicle; and a control unit configured to perform deceleration control to automatically decelerate the vehicle when a deceleration target is detected based on an image photographed by the photographing device, wherein
the control unit is configured to, when the control unit detects a notifying target that previously informs presence of a deceleration target based on an image photographed by the photographing device, set a target vehicle speed of the vehicle at a position of the deceleration target corresponding to the notifying target based on the notifying target, set a provisional deceleration pattern of the vehicle based on a vehicle speed at a time point when the notifying target was detected and the target vehicle speed, and perform temporary deceleration control to automatically decelerate the vehicle according to the provisional deceleration pattern.

2. The driving assistance device according to claim 1, wherein the control unit is configured to, when the control unit detects the deceleration target corresponding to the notifying target based on the image photographed by the photographing device in a situation where the provisional deceleration control is performed, estimate a remaining traveling distance from a present position of the vehicle to the deceleration target, set a final deceleration pattern of the vehicle based on the vehicle speed at a time point when the deceleration target was detected, the target vehicle speed, and the remaining traveling distance, and perform final deceleration control to automatically decelerate the vehicle according to the final deceleration pattern.

3. The driving assistance device according to claim 1, wherein the vehicle has a navigation device, and the control unit is configured to acquire information on a present position of the vehicle from the navigation device, and determine a start timing of the provisional deceleration control by determining whether or not the vehicle has reached a deceleration start position of the provisional deceleration pattern based on the present position of the vehicle and the provisional deceleration pattern.

4. The driving assistance device according to claim 1, wherein the control unit includes a storage device that stores, for each deceleration target, information on a standard distance between a deceleration target and a notifying target that previously informs presence of a deceleration target, and is configured to, when the control unit detects a notifying target that previously informs presence of a deceleration target, estimate a distance from the present position of the vehicle to the detected notifying target, acquire information on a standard distance corresponding to the detected notifying target from the storage device, estimate a provisional traveling distance from a present position of the vehicle to the deceleration target corresponding to the detected notifying target based on the estimated distance and the acquired standard distance, and determine a start timing of the provisional deceleration control by determining whether or not the vehicle has reached a deceleration start position of the provisional deceleration pattern based on a traveling distance of the vehicle from a time point when the notifying target was detected, the provisional traveling distance, and the provisional deceleration pattern.

5. The driving assistance device according to claim 4, wherein the vehicle has a radar device that detects a distance between the vehicle and a target in front of the vehicle, and the control unit is configured to, when the control unit detects a notifying target that previously informs presence of a deceleration target, estimate a distance from the present position of the vehicle to the notifying target based on a distance detected by the radar device.
